(19) United States
(12) Patent Application Publication
(10) Pub. No.: US 2018/0030355 A1
(43) Pub. Date: Feb. 1, 2018

(54) Mixtures Of Diphosphinic Acids And Alkylphosphinic Acids, A Process For The Preparation Thereof And The Use Thereof

(71) Applicant: Clariant International Ltd., Muttenz (CH)

(72) Inventors: Fabian SCHNEIDER, Eppelheim (DE); Frank OSTEROD, Koln (DE); Harald BAUER, Kerpen (DE); Martin SICKEN, Koln (DE)

(73) Assignee: Clariant International Ltd., Muttenz (CH)

(21) Appl. No.: 15/729,914

(22) Filed: Oct. 11, 2017

Related U.S. Application Data
(63) Continuation of application No. 14/364,807, filed on Jun. 12, 2014, now abandoned.

(30) Foreign Application Priority Data
Dec. 16, 2011 (DE) 10 2011 121 590.9

(51) Int. Cl. C09K 21/12; C07F 9/30; C07F 9/48; C08K 5/5313

(52) U.S. Cl. CPC C09K 21/12; C08K 5/5313; C07F 9/305; C07F 9/4816; C08K 2201/014

(57) ABSTRACT

Mixtures of diphosphinic acids and alkylphosphinic acids, a process for preparation thereof and use thereof

The invention relates to mixtures of at least one diphosphinic acid of the formula (I)

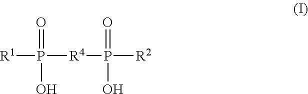

in which
R¹, R² are each H, C₁-C₁₈-alkyl, C₂-C₁₈-alkenyl, C₆-C₁₈-aryl, C₇-C₁₈-alkylaryl
R⁴ is C₁-C₁₈-alkylene, C₂-C₁₈-alkenylene, C₆-C₁₈-arylene, C₇-C₁₈-alkylarylene
   with at least one alkylphosphinic acid of the formula (II)

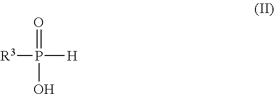

in which
R³ is C₁-C₁₈-alkyl, C₂-C₁₈-alkenyl, C₆-C₈-aryl, C₇-C₁₈-alkylaryl.

The invention also relates to a process for preparing these mixtures and to the use thereof.

The invention relates to mixtures of at least one diphosphinic acid and at least one alkylphosphinic acid, to a process for preparation thereof and to the use thereof.

In the production of printed circuit boards, which are being used to an increasing degree in various devices, for example computers, cameras, cellphones, LCD and TFT screens and other electronic devices, different materials, especially polymers, are being used. These include particularly thermosets, glass fiber-reinforced thermosets and thermoplastics. Owing to their good properties, epoxy resins are used particularly frequently.

According to the relevant standards (IPC-4101, Specification for Base Materials for Rigid and Multilayer Printed Boards), these printed circuit boards must be rendered flame-retardant.

The thermal expansion of printed circuit boards in the course of production thereof is a problem. The conditions of electronics manufacture for printed circuit boards require that printed circuit boards withstand high thermal stresses without damage or deformation. The application of conductor tracks (lead-free soldering) to printed circuit boards is effected at temperatures up to about 260° C. It is therefore important that printed circuit boards do not warp under thermal stress and the products remain dimensionally stable.

Thermal expansion is significant particularly even in the case of prepregs (short form of “preimpregnated fibers”) and laminates, since these constitute the initial forms or precursors of printed circuit boards. It is thus important to minimize the thermal expansion of test specimens in order to obtain a good, dimensionally stable product (for example a finished printed circuit board).

It is an object of the present invention to modify polymers for prepregs, printed circuit boards and laminates such that they are subject only to very low thermal expansion—if any at all—and dimensional stability is fulfilled.

This object is achieved by mixtures of at least one diphosphinic acid of the formula (I)

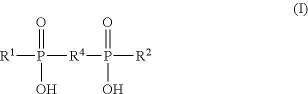

in which
R¹, R² are each H, C₁-C₁₈-alkyl, C₂-C₁₈-alkenyl, C₆-C₁₈-aryl, C₇-C₁₈-alkylaryl
R⁴ is C₁-C₁₈-alkylene, C₂-C₁₈-alkenylene, C₆-C₁₈-arylene, C₇-C₁₈-alkylarylene
   with at least one alkylphosphinic acid of the formula (II)

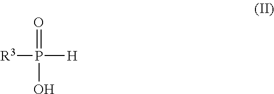

in which
R³ is C₁-C₁₈-alkyl, C₂-C₁₈-alkenyl, C₆-C₁₈-aryl, C₇-C₁₈-alkylaryl.

Preferably, R¹, R² and R³ are the same or different and are each methyl, ethyl, n-propyl, isopropyl, n-butyl, isobutyl, tert-butyl, n-pentyl, isopentyl, n-hexyl, isohexyl and/or phenyl, where R¹ and R² may also be H, and R⁴ is ethylene, butylene, hexylene or octylene.

More preferably, R¹, R² and R³ are the same or different and are each ethyl or butyl.

The mixtures preferably comprise 0.1 to 99.9% by weight of diphosphinic acid of the formula (I) and 99.9 to 0.1% by weight of alkylphosphinic acid of the formula (II).

The mixtures more preferably comprise 40 to 99.9% by weight of diphosphinic acid of the formula (I) and 60 to 0.1% by weight of alkylphosphinic acid of the formula (II).

In a further embodiment, the mixtures comprise 60 to 99.9% by weight of diphosphinic acid of the formula (I) and 40 to 0.1% by weight of alkylphosphinic acid of the formula (II).

Also of particularly good suitability are mixtures comprising 80 to 99.9% by weight of diphosphinic acid of the formula (I) and 20 to 0.1% by weight of alkylphosphinic acid of the formula (II).

Preference is likewise given to mixtures comprising 90 to 99.9% by weight of diphosphinic acid of the formula (I) and 10 to 0.1% by weight of alkylphosphinic acid of the formula (II).

Particularly suitable mixtures for many areas of application are those comprising 95 to 99.9% by weight of diphosphinic acid of the formula (I) and 5 to 0.1% by weight of alkylphosphinic acid of the formula (II).

More particularly, the mixtures comprise 98 to 99.9% by weight of diphosphinic acid of the formula (I) and 2 to 0.1% by weight of alkylphosphinic acid of the formula (II).

The invention preferably relates to mixtures of the aforementioned type in which the diphosphinic acid is ethylene-1,2-bis(ethylphosphinic acid), ethylene-1,2-bis(propylphosphinic acid), ethylene-1,2-bis(butylphosphinic acid), ethylene-1,2-bis(pentylphosphinic acid), ethylene-1,2-bis(hexylphosphinic acid), butylene-1,2-bis(ethylphosphinic acid), butylene-1,2-bis(propylphosphinic acid), butylene-1,2-bis(butylphosphinic acid), butylene-1,2-bis(pentylphosphinic acid), butylene-1,2-bis(hexylphosphinic acid), hexylene-1,2-bis(ethylphosphinic acid), hexylene-1,2-bis(propylphosphinic acid), hexylene-1,2-bis(butylphosphinic acid), hexylene-1,2-bis(pentylphosphinic acid) or hexylene-1,2-bis(hexylphosphinic acid), and the alkylphosphinic acid is ethylphosphinic acid, propylphosphinic acid, butylphosphinic acid, pentylphosphinic acid or hexylphosphinic acid.

More particularly, the present invention relates to mixtures of ethylene-1,2-bis(ethylphosphinic acid) and ethylphosphinic acid, comprising 98 to 99.9% by weight of ethylene-1,2-bis(ethylphosphinic acid) and 0.1 to 2% by weight of ethylphosphinic acid.

The inventive mixtures preferably further comprise at least one synergist, the latter being melem, melam, melon, melamine borate, melamine cyanurate, melamine phosphate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate, melamine polyphosphate, melam polyphosphate, melem polyphosphate and/or melon polyphosphate; aluminum compounds, magnesium compounds, tin compounds, antimony compounds, zinc compounds, silicon compounds, phosphorus compounds, carbodiimides, phosphazenes, piperazines, piperazine (pyro)phosphates, (poly)isocyanates and/or styrene-acrylic polymers; aluminum hydroxide, halloysites, sapphire products, boehmite, nanoboehmite; magnesium hydroxide; antimony oxides; tin oxides; zinc oxide, zinc hydroxide, zinc oxide hydrate, zinc carbonate, zinc stannate, zinc hydroxystannate, zinc silicate, zinc phosphate, zinc borophosphate, zinc borate and/or zinc molybdate; phosphinic acids and salts thereof, phosphonic acids and salts thereof and/or phosphine oxides; carbonylbiscaprolactam; nitrogen compounds from the group of oligomeric esters of tris(hydroxyethyl) isocyanurate with aromatic polycarboxylic acids, or benzoguanamine, acetoguanamine, tris(hydroxyethyl) isocyanurate, allantoin, glycoluril, cyanurates, cyanurate-epoxide compounds, urea cyanurate, dicyanamide, guanidine, guanidine phosphate and/or sulfate.

The mixtures preferably comprise 99 to 1% by weight of the mixture of diphosphinic acids of the formula (I) and alkylphosphinic acid of the formula (II) as claimed in at least one of claims 1 to 12 and 1 to 99% by weight of synergist.

The invention also relates to a process for preparing the mixtures as claimed in at least one of claims 1 to 11, wherein a phosphinic acid source is reacted with an alkyne in the presence of an initiator to give a mixture of diphosphinic acids of the formula (I) and alkylphosphinic acid of the formula (II).

Preferably, the phosphinic acid source is ethylphosphinic acid and the alkyne is acetylene, methylacetylene, 1-butyne, 1-hexyne, 2-hexyne, 1-octyne, 4-octyne, 1-butyn-4-ol, 2-butyn-1-ol, 3-butyn-1-ol, 5-hexyn-1-ol, 1-octyn-3-ol, 1-pentyne, phenylacetylene, trimethylsilylacetylene and/or diphenylacetylene.

The initiator is preferably a free-radical initiator having a nitrogen-nitrogen or an oxygen-oxygen bond.

The free-radical initiator is preferably 2,2′-azobis(2-amidinopropane) dihydrochloride, 2,2′-azobis(N,N′-dimethyleneisobutyramidine) dihydrochloride, azobis(isobutyronitrile), 4,4′-azobis(4-cyanopentanoic acid) and/or 2,2′-azobis(2-methylbutyronitrile) or hydrogen peroxide, ammonium peroxodisulfate, potassium peroxodisulfate, dibenzoyl peroxide, di-tert-butyl peroxide, peracetic acid, diisobutyryl peroxide, cumene peroxyneodecanoate, tert-butyl peroxyneodecanoate, tert-butyl peroxypivalate, tert-amyl peroxypivalate, dipropyl peroxydicarbonate, dibutyl peroxydicarbonate, dimyristyl peroxydicarbonate, dilauroyl peroxide, 1,1,3,3-tetramethylbutyl peroxy-2-ethylhexanoate, tert-amyl peroxy-2-ethylhexylcarbonate, tert-butyl peroxyisobutyrate, 1,1-di(tert-butylperoxy)cyclohexane, tert-butyl peroxybenzoate, tert-butyl peroxyacetate, tert-butyl peroxydiethylacetate, tert-butyl peroxyisopropylcarbonate, 2,2-di(tert-butylperoxy)butane, tert-amyl hydroperoxide and/or 2,5-dimethyl-2,5-di(tert-butylperoxy)hexane.

The solvent preferably comprises straight-chain or branched alkanes, alkyl-substituted aromatic solvents, water-immiscible or only partly water-miscible alcohols or ethers, water and/or acetic acid.

The alcohol is preferably methanol, propanol, i-butanol and/or n-butanol or comprises mixtures of these alcohols with water.

The reaction temperature is preferably between 50 and 150° C.

The invention also relates to the use of mixtures as claimed in at least one of claims 1 to 11 as an intermediate for further syntheses, as a binder, as a crosslinker or accelerator in the curing of epoxy resins, polyurethanes and unsaturated polyester resins, as polymer stabilizers, as crop protection compositions, as sequestrants, as a mineral oil additive, as an anticorrosive, in washing and cleaning composition applications and in electronics applications.

Particular preference is given to the use of mixtures as claimed in at least one of claims 1 to 13 as a flame retardant, especially as a flame retardant for clearcoats and intumescent coatings, as a flame retardant for wood and other cellulosic products, as a reactive and/or nonreactive flame retardant for polymers, for production of flame-retardant polymer molding compositions, for production of flame-retardant polymer moldings and/or for rendering polyester and pure and blended cellulose fabrics flame-retardant by impregnation, and as a synergist.

The invention also relates to flame-retardant thermoplastic or thermoset polymer molding compositions and polymer moldings, films, filaments and fibers comprising 0.5 to 45% by weight of mixtures as claimed in at least one of claims 1 to 13, 55 to 99.5% by weight of thermoplastic or thermoset polymer or mixtures thereof, 0 to 55% by weight of additives and 0 to 55% by weight of filler or reinforcing materials, where the sum of the components is 100% by weight.

Finally, the invention also relates to flame-retardant thermoplastic or thermoset polymer molding compositions and polymer moldings, films, filaments and fibers comprising 1 to 30% by weight of mixtures as claimed in at least one of claims 1 to 13, 10 to 95% by weight of thermoplastic or thermoset polymer or mixtures thereof, 2 to 30% by weight of additives and 2 to 30% by weight of filler or reinforcing materials, where the sum of the components is 100% by weight.

Preferably, R¹ and R² are the same or different and are each H, methyl, ethyl, n-propyl, isopropyl, n-butyl, isobutyl, tert-butyl, n-pentyl, isopentyl, n-hexyl, isohexyl and/or phenyl; R³ is (independently of R¹ and R²) methyl, ethyl, n-propyl, isopropyl, n-butyl, isobutyl, tert-butyl, n-pentyl, isopentyl, n-hexyl, isohexyl and/or phenyl, and R⁴ is ethylene, butylene, hexylene or octylene; this means the C₂, C₄, C₆ or C₈ group which connects the two phosphorus atoms.

Preferred two-component mixtures of at least one diphosphinic acid of the formula (I) and at least one alkylphosphinic acid of the formula (II) are composed of ethylene-1,2-bis(ethylphosphinic acid) and ethylphosphinic acid, ethylene-1,2-bis(ethylphosphinic acid) and propylphosphinic acid, ethylene-1,2-bis(ethylphosphinic acid) and butylphosphinic acid, ethylene-1,2-bis(ethylphosphinic acid) and pentylphosphinic acid, ethylene-1,2-bis(ethylphosphinic acid) and hexylphosphinic acid, ethylene-1,2-bis(propylphosphinic acid) and ethylphosphinic acid, ethylene-1,2-bis(propylphosphinic acid) and propylphosphinic acid, ethylene-1,2-bis(propylphosphinic acid) and butylphosphinic acid, ethylene-1,2-bis(propylphosphinic acid) and pentylphosphinic acid, ethylene-1,2-bis(propylphosphinic acid) and hexylphosphinic acid, ethylene-1,2-bis(butylphosphinic acid) and ethylphosphinic acid, ethylene-1,2-bis(butylphosphinic acid) and propylphosphinic acid, ethylene-1,2-bis(butylphosphinic acid) and butylphosphinic acid, ethylene-1,2-bis(butylphosphinic acid) and pentylphosphinic acid, ethylene-1,2-bis(butylphosphinic acid) and hexylphosphinic acid, ethylene-1,2-bis(pentylphosphinic acid) and ethylphosphinic acid, ethylene-1,2-bis(pentylphosphinic acid) and propylphosphinic acid, ethylene-1,2-bis(pentylphosphinic acid) and butylphosphinic acid, ethylene-1,2-bis(pentylphosphinic acid) and pentylphosphinic acid, ethylene-1,2-bis(pentylphosphinic acid) and hexylphosphinic acid, ethylene-1,2-bis(hexylphosphinic acid) and ethylphosphinic acid, ethylene-1,2-bis(hexylphosphinic acid) and propylphosphinic acid, ethylene-1,2-bis(hexylphosphinic acid) and butylphosphinic acid, ethylene-1,2-bis(hexylphosphinic acid) and pentylphosphinic acid, ethylene-1,2-bis(hexylphosphinic acid) and hexylphosphinic acid, butylene-1,2-bis(ethylphosphinic acid) and ethylphosphinic acid, butylene-1,2-bis(ethylphosphinic acid) and propylphosphinic acid, butylene-1,2-bis(ethylphosphinic acid) and butylphosphinic acid, butylene-1,2-bis(ethylphosphinic acid) and pentylphosphinic acid, butylene-1,2-bis(ethylphosphinic acid) and hexylphosphinic acid, butylene-1,2-bis(propylphosphinic acid) and ethylphosphinic acid, butylene-1,2-bis(propylphosphinic acid) and propylphosphinic acid, butylene-1,2-bis(propylphosphinic acid) and butylphosphinic acid, butylene-1,2-bis(propylphosphinic acid) and pentylphosphinic acid butylene-1,2-bis(propylphosphinic acid) and hexylphosphinic acid, butylene-1,2-bis(butylphosphinic acid) and ethylphosphinic acid, butylene-1,2-bis(butylphosphinic acid) and propylphosphinic acid, butylene-1,2-bis(butylphosphinic acid) and butylphosphinic acid, butylene-1,2-bis(butylphosphinic acid) and pentylphosphinic acid, butylene-1,2-bis(butylphosphinic acid) and hexylphosphinic acid, butylene-1,2-bis(pentylphosphinic acid) and ethylphosphinic acid, butylene-1,2-bis(pentylphosphinic acid) and propylphosphinic acid, butylene-1,2-bis(pentylphosphinic acid) and butylphosphinic acid, butylene-1,2-bis(pentylphosphinic acid) and pentylphosphinic acid, butylene-1,2-bis(pentylphosphinic acid) and hexylphosphinic acid, butylene-1,2-bis(hexylphosphinic acid) and ethylphosphinic acid, butylene-1,2-bis(hexylphosphinic acid) and propylphosphinic acid, butylene-1,2-bis(hexylphosphinic acid) and butylphosphinic acid, butylene-1,2-bis(hexylphosphinic acid) and pentylphosphinic acid, butylene-1,2-bis(hexylphosphinic acid) and hexylphosphinic acid, hexylene-1,2-bis(ethylphosphinic acid) and ethylphosphinic acid, hexylene-1,2-bis(ethylphosphinic acid) and propylphosphinic acid, hexylene-1,2-bis(ethylphosphinic acid) and butylphosphinic acid, hexylene-1,2-bis(ethylphosphinic acid) and pentylphosphinic acid, hexylene-1,2-bis(ethylphosphinic acid) and hexylphosphinic acid, hexylene-1,2-bis(propylphosphinic acid) and ethylphosphinic acid, hexylene-1,2-bis(propylphosphinic acid) and propylphosphinic acid, hexylene-1,2-bis(propylphosphinic acid) and butylphosphinic acid, hexylene-1,2-bis(propylphosphinic acid) and pentylphosphinic acid, hexylene-1,2-bis(propylphosphinic acid) and hexylphosphinic acid, hexylene-1,2-bis(butylphosphinic acid) and ethylphosphinic acid, hexylene-1,2-bis(butylphosphinic acid) and propylphosphinic acid, hexylene-1,2-bis(butylphosphinic acid) and butylphosphinic acid, hexylene-1,2-bis(butylphosphinic acid) and pentylphosphinic acid, hexylene-1,2-bis(butylphosphinic acid) and hexylphosphinic acid, hexylene-1,2-bis(pentylphosphinic acid) and ethylphosphinic acid, hexylene-1,2-bis(pentylphosphinic acid) and propylphosphinic acid, hexylene-1,2-bis(pentylphosphinic acid) and butylphosphinic acid, hexylene-1,2-bis(pentylphosphinic acid) and pentylphosphinic acid, hexylene-1,2-bis(pentylphosphinic acid) and hexylphosphinic acid, hexylene-1,2-bis(hexylphosphinic acid) and ethylphosphinic acid, hexylene-1,2-bis(hexylphosphinic acid) and propylphosphinic acid, hexylene-1,2-bis(hexylphosphinic acid) and butylphosphinic acid, hexylene-1,2-bis(hexylphosphinic acid) and pentylphosphinic acid, hexylene-1,2-bis(hexylphosphinic acid) and hexylphosphinic acid.

In addition, multicomponent mixtures may also occur, for example of ethylene-1,2-bis(ethylphosphinic acid), ethylphosphinic acid and butylphosphinic acid or, for instance, of ethylene-1,2-bis(ethylphosphinic acid), ethylene-1,2-bis(butylphosphinic acid), ethylphosphinic acid and butylphosphinic acid etc.

Preference is given in accordance with the invention to mixtures comprising 98 to 99.9% by weight of ethylene-1,2-bis(ethylphosphinic acid) and 0.1 to 2% by weight of ethylphosphinic acid.

The synergist is preferably an expansion-neutral substance, which means that its dimensions do not change under thermal or similar stress. Such changes can be determined by means of the coefficient of thermal expansion. This describes the changes in the dimensions of a substance in the event of temperature changes.

Preferred ratios are 99 to 50% by weight of the mixture of diphosphinic acids of the formula (I) and alkylphosphinic acid of the formula (II) as claimed in at least one of claims 1 to 12 and 1 to 50% by weight of synergist.

In the process according to the invention, a phosphinic acid source is reacted with an alkyne in the presence of an initiator. This typically involves, first of all, reacting an alkene with phosphinic acid to give an alkylphosphinic acid, which is then reacted further with an alkyne to give the inventive mixture.

Preference is given here to reacting phosphinic acid itself with ethylene in the presence of a (metallocene) catalyst to give ethylphosphinic acid and reacting the latter, after purification, with acetylene in the presence of an initiator to give the inventive mixture of a diphosphinic acid of the formula (I) with at least one alkylphosphinic acid of the formula (II).

Preference is given to processing the inventive mixtures of at least one diphosphinic acid of the formula (I) and at least one alkylphosphinic acid of the formula (II) by mixing into a polymer system.

The mixing is effected typically by kneading, dispersing and/or extruding.

Preference is given to using the inventive mixtures of at least one diphosphinic acid of the formula (I) and at least one alkylphosphinic acid of the formula (II) also by additive incorporation into a polymer system.

Particular preference is given to using mixtures of at least one diphosphinic acid of the formula (I) and at least one alkylphosphinic acid of the formula (II) by reactive incorporation into a polymer system. The reactive incorporation is characterized by a resulting, permanent bond to the polymer extrudates of the polymer system, as a result of which the inventive mixture of at least one diphosphinic acid of the formula (I) and at least one alkylphosphinic acid of the formula (II) cannot be leached out of the polymer.

Suitable polymer additives for flame-retardant polymer molding compositions and polymer moldings are UV absorbers, light stabilizers, lubricants, colorants, antistats, nucleating agents, fillers, synergists, reinforcers and others.

The polymer systems preferably originate from the group of the thermoplastic polymers such as polyamide, polyester or polystyrene and/or thermoset polymers.

The thermoset polymers are preferably epoxy resins.

The thermoset polymers are preferably epoxy resins which have been cured with resols, phenols, phenol derivatives and/or dicyandiamide, alcohols and amines.

The thermoset polymers are more preferably epoxy resins which have been cured with phenols and/or dicyandiamide and/or a catalyst.

The catalysts are preferably imidazole compounds.

The epoxy resins are preferably polyepoxide compounds.

The epoxy resins preferably originate from the group of the novolacs and the bisphenol A resins.

The polymers are preferably polymers of mono- and diolefins, for example polypropylene, polyisobutylene, polybutene-1, poly-4-methylpentene-1, polyisoprene or polybutadiene, and addition polymers of cycloolefins, for example of cyclopentene or norbornene; and also polyethylene (which may optionally be crosslinked), e.g. high-density polyethylene (HDPE), high-density high-molar mass polyethylene (HDPE-HMW), high-density ultrahigh-molar mass polyethylene (HDPE-UHMW), medium-density polyethylene (MDPE), low-density polyethylene (LDPE), linear low-density polyethylene (LLDPE), branched low-density polyethylene (BLDPE), and mixtures thereof.

The polymers are preferably copolymers of mono- and diolefins with one another or with other vinyl monomers, for example ethylene-propylene copolymers, linear low-density polyethylene (LLDPE) and mixtures thereof with low-density polyethylene (LDPE), propylene-butene-1 copolymers, propylene-isobutylene copolymers, ethylene-butene-1 copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers thereof with carbon monoxide, or ethylene-acrylic acid copolymers and salts thereof (ionomers), and also terpolymers of ethylene with propylene and a diene such as hexadiene, dicyclopentadiene or ethylidenenorbornene; and also mixtures of such copolymers with one another, e.g. polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers and alternating or random polyalkylene/carbon monoxide copolymers and mixtures thereof with other polymers, for example polyamides.

The polymers are preferably hydrocarbon resins (e.g. C₅-C₉), including hydrogenated modifications thereof (e.g. tackifier resins) and mixtures of polyalkylenes and starch.

The polymers are preferably polystyrene (Polystyrol® 143E (BASF), poly(p-methylstyrene), poly(alpha-methylstyrene).

The polymers are preferably copolymers of styrene or alpha-methylstyrene with dienes or acrylic derivatives, for example styrene-butadiene, styrene-acrylonitrile, styrene-alkyl methacrylate, styrene-butadiene-alkyl acrylate and methacrylate, styrene-maleic anhydride, styrene-acrylonitrile-methyl acrylate; more impact-resistant mixtures of styrene copolymers and another polymer, for example a polyacrylate, a diene polymer or an ethylene-propylene-diene terpolymer; and block copolymers of styrene, for example styrene-butadiene-styrene, styrene-isoprene-styrene, styrene-ethylene/butylene-styrene or styrene-ethylene/propylene-styrene.

The polymers are preferably graft copolymers of styrene or alpha-methylstyrene, for example styrene onto polybutadiene, styrene onto polybutadiene-styrene or polybutadiene-acrylonitrile copolymers, styrene and acrylonitrile (or methacrylonitrile) onto polybutadiene; styrene, acrylonitrile and methyl methacrylate onto polybutadiene; styrene and maleic anhydride onto polybutadiene; styrene, acrylonitrile and maleic anhydride or maleimide onto polybutadiene; styrene and maleimide onto polybutadiene, styrene and alkyl acrylates or alkyl methacrylates onto polybutadiene, styrene and acrylonitrile onto ethylene-propylene-diene terpolymers, styrene and acrylonitrile onto polyalkyl acrylates or polyalkyl methacrylates, styrene and acrylonitrile onto acrylate-butadiene copolymers, and mixtures thereof, as known, for example, as ABS, MBS, ASA or AES polymers.

The styrene polymers are preferably comparatively coarse-pore foam such as EPS (expanded polystyrene), e.g. Styropor (BASF) and/or foam with relatively fine pores such as XPS (extruded rigid polystyrene foam), e.g. Styrodur® (BASF). Preference is given to polystyrene foams, for example Austrotherm® XPS, Styrofoam® (Dow Chemical), Floormate®, Jackodur®, Lustron®, Roofmate®, Sagex and Telgopor®.

The polymers are preferably halogenated polymers, for example polychloroprene, chlorine rubber, chlorinated and brominated copolymer of isobutylene-isoprene (halobutyl rubber), chlorinated or chlorosulfonated polyethylene, copolymers of ethylene and chlorinated ethylene, epichlorohydrin homo- and copolymers, especially polymers of halogenated vinyl compounds, for example polyvinyl chloride, polyvinylidene chloride, polyvinyl fluoride, polyvinylidene fluoride; and copolymers thereof, such as vinyl chloride-vinylidene chloride, vinyl chloride-vinyl acetate or vinylidene chloride-vinyl acetate.

The polymers are preferably polymers which derive from alpha,beta-unsaturated acids and derivatives thereof, such as polyacrylates and polymethacrylates, polymethyl methacrylates, polyacrylamides and polyacrylonitriles impact-modified with butyl acrylate, and copolymers of the monomers mentioned with one another or with other unsaturated monomers, for example acrylonitrile-butadiene copolymers, acrylonitrile-alkyl acrylate copolymers, acrylonitrile-alkoxyalkyl acrylate copolymers, acrylonitrile-vinyl halide copolymers or acrylonitrile-alkyl methacrylate-butadiene terpolymers.

The polymers are preferably polymers which derive from unsaturated alcohols and amines or the acyl derivatives or acetals thereof, such as polyvinyl alcohol, polyvinyl acetate, stearate, benzoate or maleate, polyvinyl butyral, polyallyl phthalate, polyallylmelamine; and copolymers thereof with olefins.

The polymers are preferably homo- and copolymers of cyclic ethers, such as polyalkylene glycols, polyethylene oxide, polypropylene oxide or copolymers thereof with bisglycidyl ethers.

The polymers are preferably polyacetals, such as polyoxymethylene, and those polyoxymethylenes which contain comonomers, for example ethylene oxide; polyacetals which have been modified with thermoplastic polyurethanes, acrylates or MBS.

The polymers are preferably polyphenylene oxides and sulfides and mixtures thereof with styrene polymers or polyamides.

The polymers are preferably polyurethanes which derive from polyethers, polyesters and polybutadienes having both terminal hydroxyl groups and aliphatic or aromatic polyisocyanates, and the precursors thereof.

The polymers are preferably polyamides and copolyamides which derive from diamines and dicarboxylic acids and/or from aminocarboxylic acids or the corresponding lactams, such as nylon 2/12, nylon 4 (poly-4-aminobutyric acid, Nylon® 4, from DuPont), nylon 4/6 (poly(tetramethyleneadipamide), Nylon® 4/6, from DuPont), nylon 6 (polycaprolactam, poly-6-aminohexanoic acid, Nylon® 6, from DuPont, Akulon K122, from DSM; Zytel® 7301, from DuPont; Durethan® B 29, from Bayer), nylon 6/6 (poly(N,N′-hexamethyleneadipamide), Nylon® 6/6, from DuPont, Zytel® 101, from DuPont; Durethan A30, Durethan® AKV, Durethan® AM, from Bayer; Ultramid® A3, from BASF), nylon 6/9 (poly(hexamethylenenonanamide), Nylon® 6/9, from DuPont), nylon 6/10 (poly(hexamethylenesebacamide), Nylon® 6/10, from DuPont), nylon 6/12 (poly(hexamethylenedodecanediamide), Nylon® 6/12, from DuPont), nylon 6/66 (poly(hexamethyleneadipamide-co-caprolactam), Nylon® 6/66, from DuPont), nylon 7 (poly-7-aminoheptanoic acid, Nylon® 7, from DuPont), nylon 7,7 (polyheptamethylenepimelamide, Nylon® 7,7, from DuPont), nylon 8 (poly-8-aminooctanoic acid, Nylon® 8, from DuPont), nylon 8,8 (polyoctamethylenesuberamide, Nylon® 8,8, from DuPont), nylon 9 (poly-9-aminononanoic acid, Nylon® 9, from DuPont), nylon 9,9 (polynonamethyleneazelamide, Nylon® 9,9, from DuPont), nylon 10 (poly-10-aminodecanoic acid, Nylon® 10, from DuPont), nylon 10,9 (poly(decamethyleneazelamide), Nylon® 10.9, from DuPont), nylon 10,10 (polydecamethylenesebacamide, Nylon® 10,10, from DuPont), nylon 11 (poly-11-aminoundecanoic acid, Nylon® 11, from DuPont), nylon 12 (polylauryllactam, Nylon® 12, from DuPont, Grillamid® L20, from Ems Chemie), aromatic polyamides proceeding from m-xylene, diamine and adipic acid; polyamides prepared from hexamethylenediamine and iso- and/or terephthalic acid (polyhexamethyleneisophthalamide, polyhexamethyleneterephthalamide) and optionally an elastomer as a modifier, e.g. poly-2,4,4-trimethylhexamethyleneterephthalamide or poly-m-phenyleneisophthalamide. Block copolymers of the aforementioned polyamides with polyolefins, olefin copolymers, ionomers or chemically bonded or grafted elastomers; or with polyethers, for example with polyethylene glycol, polypropylene glycol or polytetramethylene glycol. In addition, polyamides or copolyamides modified with EPDM (ethylene-propylene-diene rubber) or ABS (acrylonitrile-butadiene-styrene); and polyamides condensed during processing (“RIM polyamide systems”).

The polymers are preferably polyureas, polyimides, polyamidimides, polyetherimides, polyesterimides, polyhydantoins and polybenzimidazoles.

The polymers are preferably polyesters which derive from dicarboxylic acids and dialcohols and/or from hydroxycarboxylic acids or the corresponding lactones, such as polyethylene terephthalate, polybutylene terephthalate (Celanex® 2500, Celanex® 2002, from Celanese; Ultradur®, from BASF), poly-1,4-dimethylolcyclohexane terephthalate, polyhydroxybenzoates, and block polyether esters which derive from polyethers with hydroxyl end groups; and also polyesters modified with polycarbonates or MBS.

The polymers are preferably polycarbonates and polyester carbonates.

The polymers are preferably polysulfones, polyether sulfones and polyether ketones.

The polymers are preferably crosslinked polymers which derive from aldehydes on the one hand, and phenols, urea or melamine on the other hand, such as phenol-formaldehyde, urea-formaldehyde and melamine-formaldehyde resins.

The polymers are preferably drying and nondrying alkyd resins.

The polymers are preferably unsaturated polyester resins which derive from copolyesters of saturated and unsaturated dicarboxylic acids with polyhydric alcohols, and vinyl compounds as crosslinking agents, and also the halogenated, flame-retardant modifications thereof.

The polymers are preferably crosslinkable acrylic resins which derive from substituted acrylic esters, for example from epoxy acrylates, urethane acrylates or polyester acrylates.

The polymers are preferably alkyd resins, polyester resins and acrylate resins which have been crosslinked with melamine resins, urea resins, isocyanates, isocyanurates, polyisocyanates or epoxy resins.

The polymers are preferably crosslinked epoxy resins which derive from aliphatic, cycloaliphatic, heterocyclic or aromatic glycidyl compounds, for example products of bisphenol A diglycidyl ethers, bisphenol F diglycidyl ethers, which are crosslinked by means of customary hardeners, for example anhydrides or amines, with or without accelerators.

The polymers are preferably mixtures (polyblends) of the abovementioned polymers, for example PP/EPDM (polypropylene/ethylene-propylene-diene rubber), polyamide/EPDM or ABS (polyamide/ethylene-propylene-diene rubber or acrylonitrile-butadiene-styrene), PVC/EVA (polyvinyl chloride/ethylene-vinyl acetate), PVC/ABS (polyvinyl chloride/acrylonitrile-butadiene-styrene), PVC/MBS (polyvinyl chloride/methacrylate-butadiene-styrene), PC/ABS (polycarbonate/acrylonitrile-butadiene-styrene), PBTP/ABS (polybutylene terephthalate/acrylonitrile-butadiene-styrene), PC/ASA (polycarbonate/acrylic ester-styrene-acrylonitrile), PC/PBT (polycarbonate/polybutylene terephthalate), PVC/CPE (polyvinyl chloride/chlorinated polyethylene), PVC/acrylate (polyvinyl chloride/acrylate, POM/thermoplastic PUR (polyoxymethylene/thermoplastic polyurethane), PC/thermoplastic PUR (polycarbonate/thermoplastic polyurethane), POM/acrylate (polyoxymethylene/acrylate), POM/MBS (polyoxymethylene/methacrylate-butadiene-styrene), PPO/HIPS (polyphenylene oxide/high-impact polystyrene), PPO/PA 6,6 (polyphenylene oxide/nylon 6,6) and copolymers, PA/HOPE (polyamide/high-density polyethylene), PA/PP (polyamide/polyethylene), PA/PPO (polyamide/polyphenylene oxide), PBT/PC/ABS (polybutylene terephthalate/polycarbonate/acrylonitrile-butadiene-styrene) and/or PBT/PET/PC (polybutylene terephthalate/polyethylene terephthalate/polycarbonate).

The polymers may be laser-markable.

The molding produced is preferably of rectangular shape with a regular or irregular base, or of cubic shape, cuboidal shape, cushion shape or prism shape.

The invention is illustrated by the examples which follow.

Production, processing and testing of flame-retardant polymer molding compositions and flame-retardant polymer moldings

The flame-retardant components are mixed with the polymer pellets and any additives and incorporated in a twin-screw extruder (model: Leistritz LSM® 30/34) at temperatures of 230 to 260° C. (PBT-GR) or of 260 to 280° C. (PA 66-GR). The homogenized polymer strand was drawn off, cooled in a water bath and then pelletized.

After sufficient drying, the molding compositions were processed on an injection molding machine (model: Aarburg Allrounder) at melt temperatures of 240 to 270° C. (PBT-GR) or of 260 to 290° C. (PA 66-GR) to give test specimens. The test specimens are tested for flame retardancy and classified using the UL 94 test (Underwriter Laboratories).

Test specimens of each mixture were used to determine the UL 94 fire class (Underwriter Laboratories) on specimens of thickness 1.5 mm.

The UL 94 fire classifications are as follows:

V-0: afterflame time never longer than 10 sec., total of afterflame times for 10 flame applications not more than 50 sec., no flaming drops, no complete consumption of the specimen, afterglow time for specimens never longer than 30 sec. after end of flame application.
V-1: afterflame time never longer than 30 sec. after end of flame application, total of afterflame times for 10 flame applications not more than 250 sec., afterglow time for specimens never longer than 60 sec. after end of flame application, other criteria as for V-0.
V-2: cotton indicator ignited by flaming drops, other criteria as for V-1.
Not classifiable (ncl): does not fulfill fire class V-2.

For some samples examined, the LOI was also measured. The LOI (Limiting Oxygen Index) is determined to ISO 4589. According to ISO 4589, the LOI corresponds to the lowest oxygen concentration in percent by volume which just still supports the combustion of the polymer in a mixture of oxygen and nitrogen. The higher the LOI the greater the nonflammability of the material tested.

| | | |
|---|---|---|
| LOI | 23 | flammable |
| LOI | 24-28 | limited flammability |
| LOI | 29-35 | flame-retardant |
| LOI | >36 | particularly flame-retardant |

### Chemicals and Abbreviations Used:

Phenol novolac: Bakelite® PF 0790, from Hexion
Initiator: Vazo 67, from DuPont

The invention is illustrated by the examples which follow.

In principle, the process according to the invention is executed in such a way that the reaction mixture is exposed only to a relatively low acetylene flow rate of about 1 l/h under the given reaction conditions. After the acetylene has been passed through the reaction solution until conversion is adequate and a sufficient time for continued reaction has elapsed, the acetylene feed is stopped and the workup is conducted under inert gas atmosphere, preferably nitrogen. For this purpose, the reaction mixture is driven out of the apparatus with nitrogen and, after cooling the reaction mixtures, the solid formed is filtered off with suction.

### EXAMPLE 1 PREPARATION OF ETHYLPHOSPHINIC ACID

At room temperature, a three-neck flask with stirrer and jacketed coil condenser is initially charged with 5852 g of tetrahydrofuran and “degassed” while stirring and passing nitrogen through, and all further reactions are executed under nitrogen. Then 70 mg of tris(dibenzylideneacetone)dipalladium and 95 mg of 4,5-bis(diphenylphosphino)-9,9-dimethylxanthene are added and the mixture is stirred for a further 15 minutes, and 198 g of phosphinic acid in 198 g of water are added. The reaction solution is transferred into a 2 l Büchi reactor. While stirring the reaction mixtures, the reactor is charged with ethylene to 2.5 bar and the reaction mixture is heated to 80° C. After 56 g of ethylene have been absorbed, the mixture is cooled to room temperature and free ethylene is burnt off.

The reaction mixture is freed from the solvent on a rotary evaporator at a maximum of 60° C. and 350-10 mbar. 300 g of demineralized water are added to the residue, and the mixture is stirred under nitrogen atmosphere at room temperature for 1 hour. The resulting residue is filtered and the filtrate is extracted with 200 ml of toluene. The aqueous phase is freed from the solvent on a rotary evaporator at a maximum of 60° C. and 250-10 mbar.

31_{P} NMR (D₂O, coupled): doublet of multiplet, 36.7 ppm; ethylphosphinic acid.

### EXAMPLE 2

0.5 mol of ethylphosphinic acid (prepared according to example 1) are initially charged in butanol as a solvent and inertized with a nitrogen gas stream while stirring for 30 minutes and heated to 80° C. Acetylene is passed through the reaction solution at 1 l/h, and 0.2 mol % of initiator is metered in over 3 hours. After a continued reaction period of 30 minutes, the acetylene feed is stopped and acetylene is driven out of the apparatus with nitrogen. After the reaction mixtures have been cooled, the solid formed is filtered off with suction and redispersed with 75 g of acetone, washed and dried in a vacuum drying cabinet at 100° C. for 4 hours. In a yield of 62%, 33.2 g of a mixture of ethylene-1,2-bis(ethylphosphinic acid) (99.9% by weight) and ethylphosphinic acid (0.1% by weight) are obtained.

### EXAMPLE 3

0.5 mol of ethylphosphinic acid (prepared according to example 1) are initially charged in butanol as a solvent and inertized with a nitrogen gas stream while stirring for 30 minutes and heated to 80° C. Acetylene is passed through the reaction solution at 1 l/h, and 0.2 mol % of initiator is metered in over 2.5 hours. After a continued reaction period of 30 minutes, the acetylene feed is stopped and acetylene is driven out of the apparatus with nitrogen. After the reaction mixture has been cooled, the solid formed is filtered off with suction and redispersed with 75 g of acetone, washed and dried in a vacuum drying cabinet at 100° C. for 4 hours. In a yield of 64%, 34.2 g of a mixture of ethylene-1,2-bis(ethylphosphinic acid) (98% by weight) and ethylphosphinic acid (2% by weight) are obtained.

### EXAMPLE 4

0.5 mol of ethylphosphinic acid (prepared according to example 1) are initially charged in butanol as a solvent and inertized with a nitrogen gas stream while stirring for 30 minutes and heated to 80° C. Acetylene is passed through the reaction solution at 1 l/h, and 0.2 mol % of initiator is metered in over 2 hours. After a continued reaction period of 30 minutes, the acetylene feed is stopped and acetylene is driven out of the apparatus with nitrogen. After the reaction mixtures have been cooled, the solid formed is filtered off with suction and redispersed with 75 g of acetone, washed and dried in a vacuum drying cabinet at 100° C. for 4 hours. In a yield of 64%, 33.8 g of a mixture of ethylene-1,2-bis(ethylphosphinic acid) (90% by weight) and ethylphosphinic acid (10% by weight) are obtained.

### EXAMPLE 5

0.5 mol of ethylphosphinic acid (prepared according to example 1) are initially charged in butanol as a solvent and inertized with a nitrogen gas stream while stirring for 30 minutes and heated to 60° C. Acetylene is passed through the reaction solution at 1 l/h, and 0.12 mol % of initiator is metered in over 2 hours. After a continued reaction period of 30 minutes, the acetylene feed is stopped and acetylene is driven out of the apparatus with nitrogen. After the reaction mixture has been cooled, the solid formed is filtered off with suction and redispersed with 75 g of acetone, washed and dried in a vacuum drying cabinet at 100° C. for 4 hours. In a yield of 72%, 36.6 g of a mixture of ethylene-1,2-bis(ethylphosphinic acid) (60% by weight) and ethylphosphinic acid (40% by weight) are obtained.

### EXAMPLE 6

0.5 mol of ethylphosphinic acid (prepared according to example 1) are initially charged in butanol as a solvent and inertized with a nitrogen gas stream while stirring for 30 minutes and heated to 60° C. Acetylene is passed through the reaction solution at 1 l/h, and 0.05 mol % of initiator is metered in over 2 hours. After a continued reaction period of 30 minutes, the acetylene feed is stopped and acetylene is driven out of the apparatus with nitrogen. After the reaction mixture has been cooled, the solid formed is filtered off with suction and redispersed with 75 g of acetone, washed and dried in a vacuum drying cabinet at 100° C. for 4 hours. In a yield of 74%, 37.2 g of a mixture of ethylene-1,2-bis(ethylphosphinic acid) (50% by weight) and ethylphosphinic acid (50% by weight) are obtained.

### Method for Producing Polymer Moldings:

### a) Preparation of Phosphorus-Modified Epoxy Resin

A 2 l five-neck flask apparatus is initially charged with 1000 g of the epoxy resin (e.g. Beckopox EP 140). It is heated to 110° C. for one hour and volatile components are removed under reduced pressure. Thereafter, the reaction mixture is inertized with nitrogen and the temperature in the flask is increased to 170° C. 118 g of the mixtures of the phosphorus compounds are added in each case, while stirring under flowing nitrogen, and an exothermic reaction is observed. The resulting resin is yellow in color and free-flowing.

### b) Production of Epoxy Resin Specimens

100 parts of the phosphorus-modified epoxy resin are mixed with one corresponding OH equivalent of phenol novolac (hydroxide equivalents 105 g/mol, melting point 85-95° C.) and heated to 150° C. This liquefies the components. The mixture is stirred gradually until a homogeneous mixture has formed and is allowed to cool to 130° C. Then 0.03 part 2-phenylimidazole is added and the mixture is stirred once again for 5-10 min. Thereafter, the mixture is poured warm into a dish and cured at 140° C. for 2 h and at 200° C. for 2 h.

### c) Production of Epoxy Resin Laminate

100 parts phosphorus-modified epoxy resin as per b) are added to 63 parts acetone and 27 parts Dowanol® PM, and the appropriate amount of phenol resin is added. The mixture is left to stir for 30 min and then 2-phenylimidazole is added. Thereafter, the mixture is filtered through a 400 μm sieve in order to remove excess resin particles. Then a woven glass fabric (7628 type, 203 g/m²) is immersed into the solution until complete wetting of the fabric has taken place. The wetted fabric is pulled out of the mixture and excess resin is removed. Thereafter, the wetted fabric is initially cured in stages in a drying cabinet for a brief period at temperatures up to 165° C. and then fully cured in a heated press. The resin content of the cured laminates is 30-50% by weight. The thermal expansion of the molding produced, a laminate, is determined to ASTM E831-06.

### EXAMPLE 7

According to the method for producing a polymer molding, 100% by weight of a bisphenol A resin is used to produce a laminate. This has the values for the coefficient of thermal expansion reported in the table.

### EXAMPLE 8

Pure ethylene-1,2-bis(ethylphosphinic acid) is obtained according to example 2 with subsequent washing of the product with organic solvents.

According to the method for producing a polymer molding, a composition composed to 90% by weight of bisphenol A resin with hardener and catalyst and 10% by weight of ethylene-1,2-bis(ethylphosphinic acid) is used to produce a molding.

### EXAMPLE 9

According to the general method for producing a polymer molding, a composition composed to 90% by weight of bisphenol A resin with hardener and catalyst and 10% by weight of ethylphosphinic acid (obtained according to example 1) is used to produce a molding.

### EXAMPLE 10

According to the general method for producing a polymer molding, a composition composed to 90% by weight of bisphenol A resin with hardener and catalyst and 10% by weight of the inventive mixture of ethylene-1,2-bis(ethylphosphinic acid) and ethylphosphinic acid according to example 2 is used to produce a molding.

### EXAMPLE 11

According to the general method for producing a polymer molding, a composition composed to 90% by weight of bisphenol A resin with hardener and catalyst and 10% by weight of the inventive mixture of ethylene-1,2-bis(ethylphosphinic acid) and ethylphosphinic acid from example 3 is used to produce a molding.

### EXAMPLE 12

According to the general method for producing a polymer molding, a composition composed to 90% by weight of bisphenol A resin with hardener and catalyst and 10% by weight of the inventive mixture of ethylene-1,2-bis(ethylphosphinic acid) and ethylphosphinic acid from example 4 is used to produce a molding.

### EXAMPLE 13

According to the general method for producing a polymer molding, a composition composed to 90% by weight of bisphenol A resin with hardener and catalyst and 10% by weight of the inventive mixture of ethylene-1,2-bis(ethylphosphinic acid) and ethylphosphinic acid from example 5 is used to produce a molding.

### EXAMPLE 14

According to the general method for producing a polymer molding, a composition composed to 90% by weight of bisphenol A resin with hardener and catalyst and 10% by weight of the inventive mixture of ethylene-1,2-bis(ethylphosphinic acid) and ethylphosphinic acid from example 6 is used to produce a molding.

The results are reproduced in the following table:

| | Composition | | Coefficient | | |
|---|---|---|---|---|---|
| | of polymer | Mixture of | of thermal | | |
| | system/ | ethylene-1,2-bis- | expansion | | |
| | substance | (ethylphosphinic acid)/ | 0°-100° [ppm/° C.] | | |
| Example | mixture | ethylphosphinic acid | Z | X | Y |
| 7 | 100:0 | | 69 | 20 | 7 |
| 8 | 90:10 | 100:0 | 68 | 20 | 7 |
| 9 | 90:10 | 0:100 | 70 | 21 | 7 |
| 10 | 90:10 | 99.9:0.1 | 66 | 18 | 5 |
| | | (from example 2) | | | |
| 11 | 90:10 | 98:2 | 63 | 16 | 5 |
| | | (from example 3) | | | |
| 12 | 90:10 | 90:10 | 60 | 16 | 5 |
| | | (from example 4) | | | |

The mixtures from examples 5 and 6 likewise give rise to a decrease in the coefficients of thermal expansion.

Compared to the pure laminate (example 7), there is a decrease in the values for the laminate comprising the inventive mixture of ethylene-1,2-bis(ethylphosphinic acid) and ethylphosphinic acid; thermal expansion is thus very low. An increase in the ethylphosphinic acid content brings about a further improvement.

Compared to the prior art (example 7), the inventive mixtures exhibit lower values for the coefficient of thermal expansion, meaning that the inventive products lead to lower expansion of the moldings produced and hence meet the demands on dimensional stability.

### EXAMPLE 15: PRODUCTION OF POLYESTER-BASED POLYMER MOLDINGS

### a) Preparation of Phosphorus-Modified Polyethylene Terephthalate

1000 g of dimethyl terephthalate are transesterified with 720 ml of ethylene glycol and 230 mg of Mn(OCOCH₃)₄*4H₂O at temperatures of 170-220° C. under a nitrogen atmosphere. After the methanol has been separated out, 17.2 g of the inventive mixture from example 4 are added at 220° C. and, after addition of 350 mg of Sb₂O₃, the reaction vessel is heated further to 250° C. and a vacuum is applied simultaneously. The polymerization is effected at 0.2 mm Hg and 287° C. within 2 hours. The resulting product has a melting point of 240-244° C. and a phosphorus content of 0.5%.

### b) Production of Polymer Moldings

The aforementioned polymer pellets are mixed with any additives and they are incorporated in a twin-screw extruder (model: Leistritz LSM 30/34) at temperatures of 250 to 290° C. (PET-GR). The homogenized polymer strand was drawn off, cooled in a water bath and then pelletized. After sufficient drying, the molding compositions were processed on an injection molding machine (model: Aarburg Allrounder) at melt temperatures of 250 to 300° C. (PET-GR) to give test specimens. The UL 94 fire class and the LOI were determined on test specimens of thickness 1.6 mm. Moldings of thickness 1.6 mm result in V-0 and an LOI of 28%.

1.-20. (canceled)

21. An intermediate for further syntheses, a binder, a crosslinker or accelerator in the curing of epoxy resins, polyurethanes and unsaturated polyester resins, a polymer stabilizer, a crop protection composition, a sequestrant, a mineral oil additive, an anticorrosive, a washing compound, a cleaning composition or an electronic composition comprising a mixture including at least one diphosphinic acid of the formula (I) 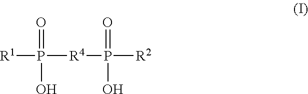
wherein
R¹ and R² are methyl, ethyl, n-propyl, isopropyl, n-butyl, isobutyl, tert-butyl, n-pentyl, isopentyl or a mixture thereof;
R⁴ is ethylene, butylene or hexylene;
with at least one alkylphosphinic acid of the formula (II) 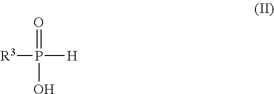
wherein
R³ is methyl, ethyl, n-propyl, isopropyl, n-butyl, isobutyl, tert-butyl, n-pentyl, isopentyl or a mixture thereof.

22. A flame retardant, a flame-retardant polymer molding composition, a flame retardant for rendering polyester and pure and blended cellulose fabrics flame-retardant by impregnation, or as a synergist comprising a mixture including at least one diphosphinic acid of the formula (I) 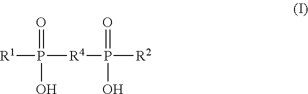
wherein
R¹, R² are methyl, ethyl, n-propyl, isopropyl, n-butyl, isobutyl, tert-butyl, n-pentyl, isopentyl or a mixture thereof;
R⁴ is ethylene, butylene or hexylene;
with at least one alkylphosphinic acid of the formula (II) 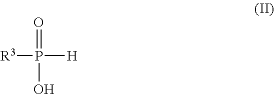
wherein
R³ is methyl, ethyl, n-propyl, isopropyl, n-butyl, isobutyl, tert-butyl, n-pentyl, isopentyl or a mixture thereof.

23.-24. (canceled)
